(19) United States
(12) Patent Application Publication
(10) Pub. No.: US 2002/0196803 A1
(43) Pub. Date: Dec. 26, 2002

(54) Communications network and communication system

(76) Inventor: Takeshi Ota, Tokyo (JP)

Correspondence Address: NOTARO AND MICHALOS, 100 DUTCH HILL ROAD, SUITE 110, ORANGEBURG, NY, 10962-2100, US

(21) Appl. No.: 10/168,221

(22) PCT Filed: Dec. 21, 2000
(86) PCT No.: PCT/JP00/09087

(30) Foreign Application Priority Data
Dec. 22, 1999 (JP) 11/364466

(51) Int. Cl. H04L 12/56

(52) U.S. Cl. 370/442; 370/451

(57) ABSTRACT

A communication technique capable of flexibly using traffic between packets requiring a real-time service and packets not requiring that service. A main transmission channel 11 is time-division-controlled, and terminals respectively assigned divided time slots 51-54 transmit packets 21-24 using as much portions of time slots as needed to free the remaining portions of time slots. Other terminals share the remaining portions of time slots according to a contention type protocol to transmit packets 31-36.

### TECHNICAL FIELD

The present invention relates to a communications network and a method of communications suitable for transmitting signals in real-time, and further to a local area network.

### BACKGROUND ART

FIG. 11 shows a conventional local area network that has been proposed for transmitting data in real-time. As shown in the drawing, the communications network is provided with terminals 201, 202, 203, 204, 205, and 206; a time-division multiplexing controller 210; and two transmission channels 211 and 212. These transmission channels consist of separate optical fibers, separate copper wires or wavelength multiplexing in same fiber. The transmission channels 211 and 212 are configured as a shared bus. The terminals 201, 202, 203, 204, 205, and 206 and the time-division multiplexing controller 210 are all connected to the transmission channels 211 and 212.

The transmission channel 211 is controlled according to a contention (random access) protocol such as Carrier Sense Multiple Access with Collision Detection (CSMA/CD). The transmission channel 212 is controlled by the Time Division Multiple Access (TDMA) protocol.

The time-division multiplexing controller 210 controls the timeslots for the transmission channel 212. Normally, the terminals 201, 202, 203, 204, 205, and 206 obtain timeslot allocations for the transmission channel 212 by transmitting a timeslot request to the time-division multiplexing controller 210 via the transmission channel 211 controlled by the CSMA/CD protocol. However, the transmission channel 211 transmits not only requests for timeslot allocations, but also packets not requiring real-time transmission. This type of network has been described in Japanese unexamined patent application publications nos. JPUPA (Japanese Published Unexamined Patent Application) HEI-2-98253 and JPUPA HEI-3-270432 and U.S. Pat. No. 5,144,466.

However, the communications network described above divides transmission lines according to packets requesting real-time transmission and those not requesting real-time transmission, resulting in poor efficiency in communication line use. For example, if a large amount of packets requesting real-time are issued with few packets that do not require real-time transmission, the transmission channel 211 will be free while the transmission channel 212 is extremely congested. In this example of the prior art, the capacities of the two transmission channels are not mutually accommodating.

### DISCLOSURE OF THE INVENTION

In view of the foregoing, it is an object of the present invention to provide a communications method capable of improving the efficiency of line use when packets requesting real-time transmission are mixed with packets not requesting real-time transmission.

According to the subject invention, the above mentioned object will be attained by a communications network comprising a broadband main transmission channel; a narrow band sub transmission channel; a plurality of terminals; a time-division controller for performing time-division control for the main transmission channel, the communication network further comprising optical transmitter/receivers for inserting the sub transmission channel into a blank region in a frequency spectrum of the main transmission channel. Further, in the communications method according to the present invention, control signals are transmitted through the sub transmission channel from the time-division controller to each of the terminals in order to perform the time-division control. Each of the terminals, after consuming only needed time of an allocated timeslot, releases remaining time in the timeslot to other terminals as remainder timeslot. The terminals also transmit requests for timeslot allocations to the time-division controller via the remainder timeslot using a contention protocol. In addition, the terminals use a plurality of buffers classified according to the priority level or the packet, and upon receipt of a use authority for a timeslot from the time-division controller, transmit packets having the highest priority. Furthermore, in a communications method suitable for a communications network comprising a single main transmission channel; a plurality or terminals; and a time-division controller for performing time-division control for the main transmission channel, the time-division controller allocates timeslots by forcefully generating collisions on the transmission channel according to the back pressure method. After using only the needed time of an allocated timeslot, the terminal to which the timeslot was allocated opens the remaining time in the timeslot to other terminals as a remainder timeslot.

With this construction, prescribed timeslots can be allocated to each terminal, enabling the transmission of packets requesting real-time transmission. Normally, a timeslot allocation scheme for real-time signals is adjusted to a traffic peak condition. Therefore, a lot of time in the timeslots is not used. With the construction described above, however, terminals use only the portion of the allocated timeslots that they need and release the remainder slot to other terminals. Accordingly, the communications network of the present invention mutually accommodates packets that require real-time transmission and those that do not, thereby achieving a high efficiency in line use.

### BRIEF DESCRIPTION OF THE DRAWINGS

FIG. 1 is a diagram showing a communications network according to a first embodiment of the present invention,

FIG. 2 is a timing chart illustrating the behavior of the communications network in FIG. 1;

FIG. 3 in a block diagram showing an optical transmitter receiver;

FIG. 4 is a graph showing the power spectrum for the main and sub transmission channels in the optical transmitter/receiver of FIG. 3;

FIG. 5 is a block diagram snowing the internal construction of terminals 1 through 6,

FIG. 6 is a timing chart showing the transmission timing in a transmission unit for the main transmission channel;

FIG. 7 is a block diagram illustrating the procedure in which terminals send requests for timeslot allocations to the time-division multiplexing controller;

FIG. 8 is a block diagram showing a terminal used in the communications network according to a second embodiment;

FIG. 9 shows a communications network according to a third embodiment;

FIG. 10 is a timing chart for the communications network of the third embodiment; and

FIG. 11 is a block diagram showing a conventional local area network for real-time communications.

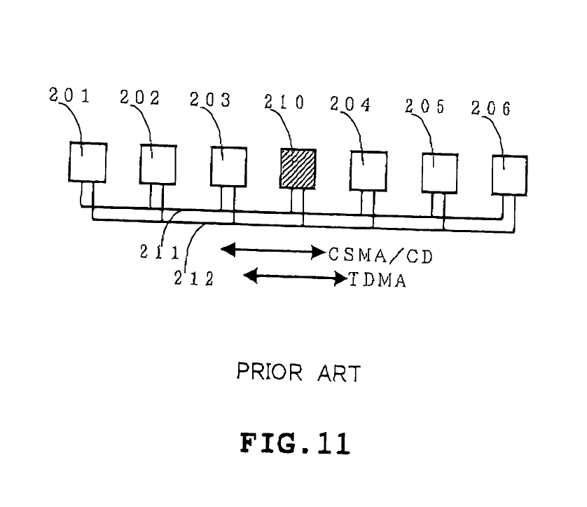

### BEST MODE FOR CARRYING OUT THE INVENTION

A communications network according to preferred embodiments of the present invention will be described below.

[The first embodiment]

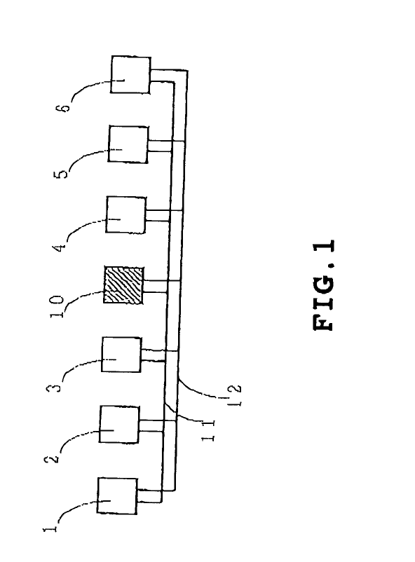

FIG. 1 shows a communications network according to the first embodiment of the present invention. The communications network includes terminals 1, 2, 3, 4, 5, and 6; a time-division multiplexing controller 10; a main transmission channel 11; and a sub transmission channel 12. The main and sub transmission channels 11 and 12 are configured as a shared bus. In the main transmission channel 11, signals having a data rate of 1-Gbps are encoded by the 8B/10B encoding scheme and transferred at a symbol rate of 1.25 Gbps. In the sub transmission channel 12, signals having a data rate of 40 Mbps are encoded by the 4B/5a encoding scheme and transferred at a symbol rate of 50 Mbps. All terminals 1, 2, 3, 4, 5, and 6 and the time-division multiplexing controller 10 are connected to the main and sub transmission channels 11 and 12. While the communications network of the present embodiment includes six terminals, this number can be set to any number two or greater.

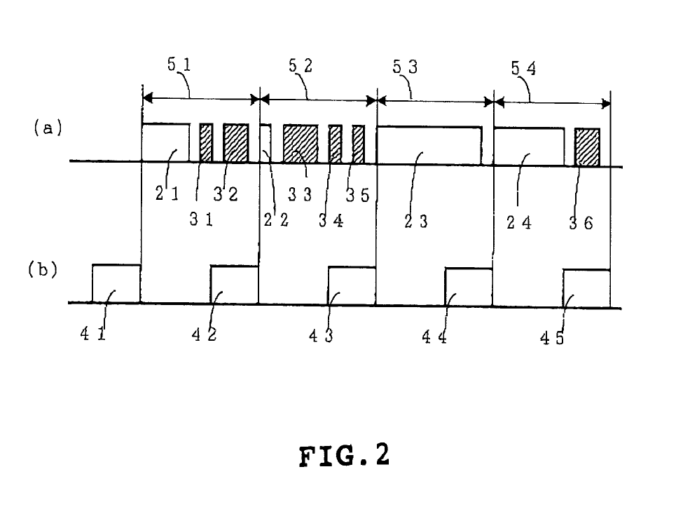

FIG. 2 is a timing chart showing the behavior of the communications network in FIG. 1. The main transmission channel 11 is divided into timeslots 51, 52, 53, and 54. Each timeslot is allocated to a terminal by the time-division multiplexing controller 10. The time-division multiplexing controller 10 performs this allocation by transmitting packets 41, 42, 43, 44, and 45 via the sub transmission channel 12. For example, the packet 41 includes a command allocating the timeslot 51 to the terminal 1. As a result, the terminal 1 transmits a packet 21. Since the packet 21 is shorter than the timeslot 51, the terminal 1 opens the main transmission channel 11 after completing transmission of the packet 21. When terminals other than the terminal 1 detect that the main transmission channel 11 is free, they transmit packets 31 and 32 to the main transmission channel 11 using a random access method. The time remaining in the timeslot 51 after the terminal 1 has transmitted the packet 21 is referred to as the “remainder slot” in the present specification.

Generally, for signals that must be transmitted in real-time, the band widths required for peak traffic are reserved. Hence, often only a portion of the timeslot is actually being used, while the remainder slot goes unused. The present invention improves the efficiency of line use by freeing the remainder slot using a contention (random access) method.

Similarly, the timeslot 52 is allocated to the terminal 2 by means of a clear-to-send packet. Since the terminal 2 transmits an extremely short packet 22 and thereafter releases the main transmission channel 11, multiple packets 33, 34, and 35 can be transmitted from other terminals using the random access method.

Next, the timeslot 53 is allocated to the terminal 3. The terminal 3 transmits a long packet 23 that uses almost the entire timeslot 53. Therefore, no other packets can be transmitted using the random access method in the timeslot 53. Hereafter, timeslots are allocated in the same manner. While only four timeslots are shown in FIG. 2 for purposes of explanation, it is obvious that time-division control is actually conducted in many timeslots using the procedure described above.

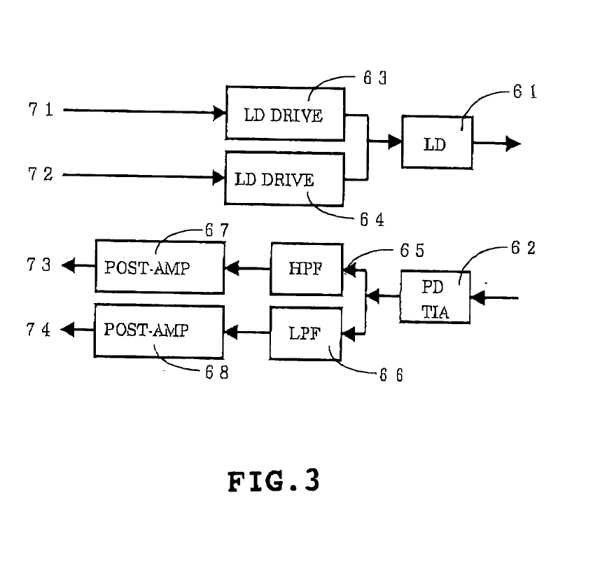

For example, the above transmission channels 11 and 12 can be constructed by combining a passive star coupler (not shown) with an optical transmitter/receiver shown in the block diagram of FIG. 3.

FIG. 3 is a block diagram showing an optical transmitter/receiver according to a first embodiment of the present invention. Data for a main transmission channel is transmitted via a main transmission channel input terminal 71 to a laser diode drive circuit 63. Data for a sub transmission channel is transmitted via a sub transmission channel input terminal 72 to a laser diode drive circuit 64. The modulated currents from the laser diode drive circuit 63 and laser diode drive circuit 64 are added to drive a laser diode 61.

An optical signal transmitted to a photodiode transimpedance amplifier 62 via an optical fiber (not shown) is converted into an electrical signal through photoelectric transfer and amplified by the photodiode transimpedance amplifier 62. The electrical signal is split by a high-pass filter 65 and a low-pass filter 66. The waveforms of each signals which are output of each filter are shaped by a post-amp 67 and a post-amp 68, respectively. The signal output from the post-amp 67 is the reception signal for the main transmission channel and is transmitted via a main transmission channel output terminal 73. The signal output from the post-amp 68 is the reception signal for the sub transmission channel and is transmitted via a sub transmission channel output terminal 74.

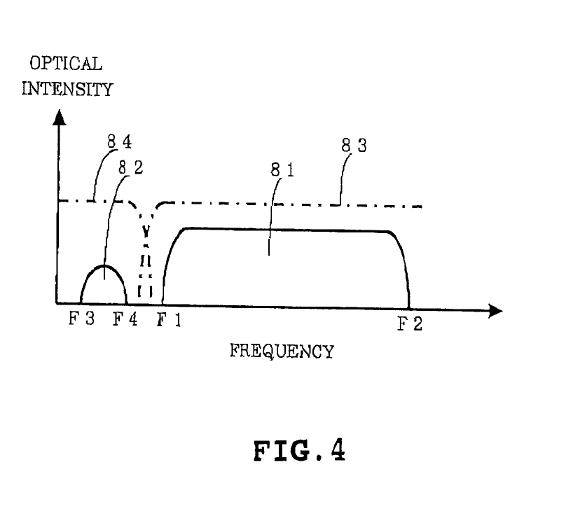

FIG. 4 is a graph showing the operating principles of the optical transmitter/receiver of FIG. 3. The X-axis of the graph represents frequency, while the Y-axis of the graph represents optical intensity. Since the 8B/10B code is an encryption form using redundancy, a blank band of power spectrum exists in the low-frequency range. That is, a power spectrum 81 for the main transmission channel exists in the range between a lower limit F1 and an upper limit F2. A power spectrum 82 for the sub transmission channel exists in the range between a lower limit F3 and an upper limit F4. A transmission rate and encoding format for the main and sub transmission channels are chosen such that F1 is greater than F4. Since the power spectra 81 and 82 do not overlap, they can be separated by suitable filters. The reference numerals 83 and 84 represent the filter characteristics of the high-pass filter 65 and low-pass filter 66, respectively.

Each of the terminals 1, 2, 3, 4, 5, and 6 and the time-division multiplexing controller 10 of FIG. 1 is equipped the optical transmitter/receiver shown in FIG. 3, and the input/output signals of the optical transmitter/receiver are distributed by the optical fibers and the passive star coupler (not shown). With this construction, the communications network includes two shared bus transmission channels constructed of the transmission channels 11 and 12. Using this method, it is possible to construct a broadband main transmission channel and a narrowband sub transmission channel more cheaply than when using wavelength multiplexing and the like.

Although main and sub transmission channels were constructed using frequency multiplexing in the optical communications network of the present embodiment, the communications network of FIG. 1 can also be constructed according to other methods. For example, an optical fiber communications network can be constructed with main and sub transmission channels through wavelength multiplexing rather than frequency multiplexing. The main and sub transmission channels can also be constructed with two optical fibers. Further, frequency multiplexing can be performed using a copper cable or two circuits or copper cables. Other possible methods include frequency multiplexing or spread spectrum multiplexing processes using radio waves.

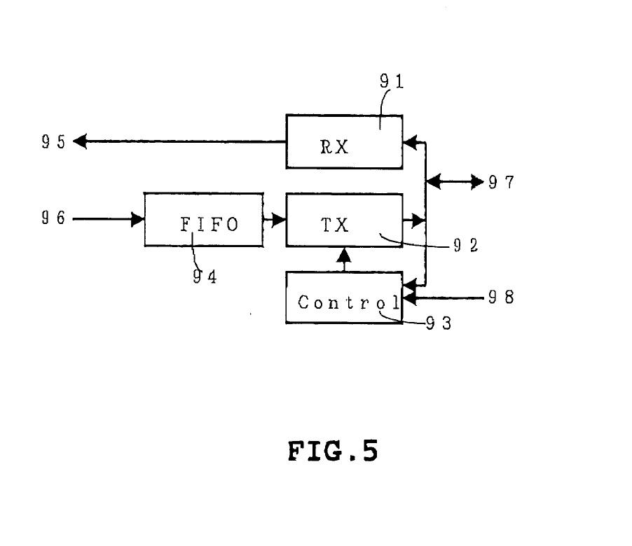

FIG. 5 is a block diagram showing the internal construction of any of the terminals 1 through 6. The terminal includes a physical layer interface 97 for the main transmission channel. A receiver 91 and transmitter 92 for the main transmission channel 11 are connected to the physical layer interface 97. A controller 93 is connected to the physical layer interface 97 and a sub transmission channel interface 98 for controlling the transmission timing of the receiver 91. The terminal also includes a buffer 94 and upper layer interfaces 95 and 96.

Signals transmitted from the physical layer interface 97 are received by the receiver 91. The receiver 91 performs packet filtering on the signals and transmits them to the interface 95. Here, packet filtering is a process for checking the destination address written in the packet and determining whether the packet should be received. Packets transmitted via the upper layer transmission interface 96 are stored in the buffer 94 in a first in first out (FIFO) method. From the buffer 94, packets are transmitted to the physical layer interface 97 via the transmitter 92. The controller 93 controls the timing or transmissions performed by the transmitter 92 based on signals received from the physical layer interface 97 and sub transmission channel interface 98.

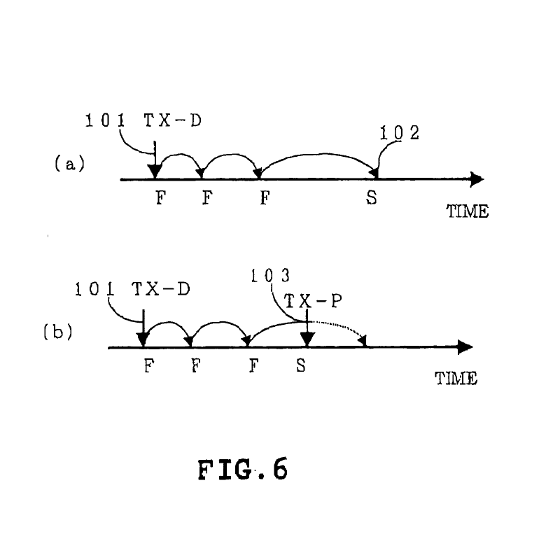

FIG. 6 is a timing chart illustrating an example timing for transmissions by the transmitter 92. In general, terminals in the network of FIG. 1 perform communications according to the protocol CSMA/CD well known in the art. For example, when a request-to send 101 is issued from the upper layers in the terminal 1, the terminal 1 checks whether a signal from another terminal exists in the main transmission channel 11, as shown in FIG. 6(a). The terminal 1 begins transmission if the main transmission channel is open, but backs off (stands by) if another terminal is using the main transmission channel 11. As shown in FIG. 6(a), three transmission attempts failed, but the fourth request-to-send 102 was successful.

In addition to the CSMA/CD protocol access method, the communications network of the present invention performs timeslot allocating control via the sub transmission channel. As shown in FIG. 6(b), a timeslot allocation 103 is issued from the sub transmission channel to the terminal 1 during the third back off (standby). More specifically, this timeslot allocation 103 indicates that a packet directing timeslot allocation from the time-division multiplexing controller 10 to the terminal 1 has been sent via the sub transmission channel 12 to all terminals on the network. In this case, the terminal 1 can immediately begin transmission. At the point in the timing chart that the timeslot allocation 103 was issued, the terminal using the main transmission channel 11, for example the terminal 2, immediately stops transmission and enters back-off (standby) mode.

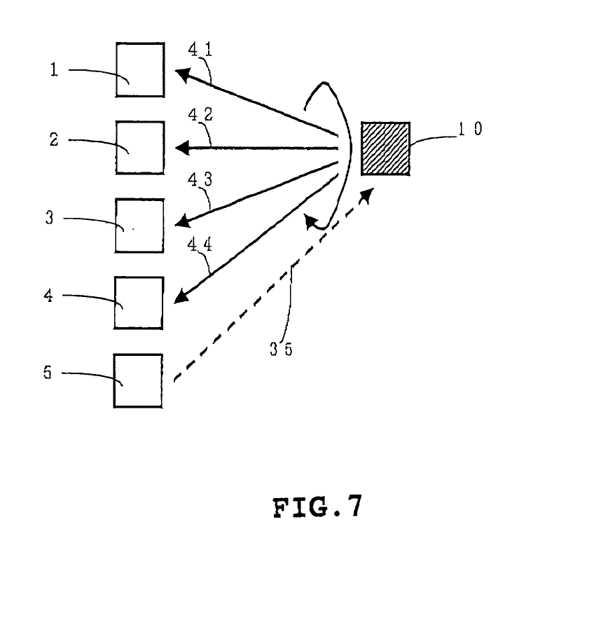

FIG. 7 illustrates the procedure in which each terminal sends timeslot allocation requests (request-to-send) to the time-division multiplexing controller 10. In this example, timeslots have already been allocated to the terminals 1, 2, 3, and 4. Therefore, the time-division multiplexing controller 10 cyclically transmits clear-to-send packets 41, 42, 43, and 44 to each of the terminals allocating timeslots on the sub transmission channel 12. During this cycle of transmission processes, the terminal 5 also wishes to perform a transmission. Accordingly, when the main transmission channel 11 is open (remainder slot), the terminal 5 sends a request-to-send packet 35 according to CSMA/CD protocol to the time-division multiplexing controller 10 via the main transmission channel 11. The time-division multiplexing controller 10 processes this request according to a prescribe algorithm and starts a timeslot allocation for the terminal 5. Here the time-division multiplexing controller 10 does not allocate all the timeslots but leaves some leeway in order that terminals have available timeslots on the main transmission channel to transmit request-to-send packets to the time-division multiplexing controller 10.

With this control process, each terminal reserves a minimum transmission band equivalent to the timeslots allocated regularly by the time-division multiplexing controller 10. Further, since the terminals release the main transmission channel 11 as a remainder slot after the required portion of the timeslot has been used, other terminals are able to transmit packets based on CSMA/CD protocol in these remainder slots. Accordingly, use of the main transmission channel 11 can be maintained at a high level of efficiency. Further, if the time-division multiplexing controller 10 goes down (quits operating) for any reason, the main transmission channel will not lose all its functions but will continue to operate based on the CSMA/CD protocol.

It is also possible to detect transmission authorization packets from the time-division multiplexing controller 10 for checking connections at the physical level. This process of detecting connections can also be used for eyesafe interlock control to prevent injury to the eyes. Since the sub transmission channel uses a slow transmission rate, the minimum reception sensitivity of the channel can be minimized, thereby reducing the transmission power. Here, a simple type of eyesafe interlock can be achieved by enabling the terminal to transmit data on the main transmission channel after detecting signals in the sub transmission channel. Eyesafe interlock is a safety mechanism for preventing damage to the human eye caused by laser light leaking from the optical transmitter/receiver when a cable becomes disconnected.

[The second embodiment]

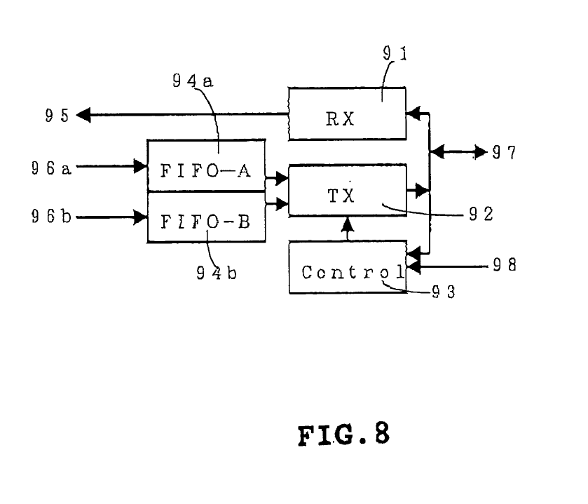

FIG. 8 is a block diagram showing a terminal used in the communications network according to the second embodiment. The upper layer interface on the transmission end of the terminal is divided into interfaces 96a and 96b. The terminal includes buffers 94a and 94b corresponding to these interfaces.

Packets (including audio and video data and the like) requesting real-time transmission are stored in the buffer 94a. Packets not requiring real-time transmission are stored in the buffer 94b. Packets in the buffer 94a are transmitted during timeslot allocations for the relevant terminal. Packets stored in the buffer 94b are transmitted using remainder timeslots.

With this construction, it is possible to conduct reliable transmission of signals requesting real-time. When a terminal such as that shown in FIG. 5 has only one buffer, packets that do not require real-time transmission can be placed at the top of the buffer 94. In this case, packets not requiring real-time transmission are transmitted in a precious allocated timeslot. The packets stored toward the bottom of the buffer 94 and actually requiring real-time transmission may not be transmitted.

Accordingly, real-time transmission can be more accurately maintained by providing two buffers as described above and processing the priority level. It is also possible to provide three or more buffers to perform a more detailed process of prioritization. Further, the buffers can be constructed so that packets in the buffer 94b are transmitted during allocated timeslots remaining after the buffer 94a becomes empty.

[The third embodiment]

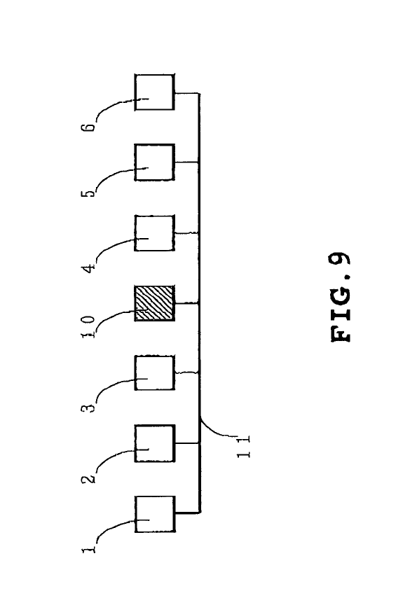

FIG. 9 shows a communications network according to a third embodiment of the present invention. The communications network of FIG. 9 differs from that in FIG. 1 by the number of transmission channels. The communications network or the third embodiment is provided with only one transmission channel.

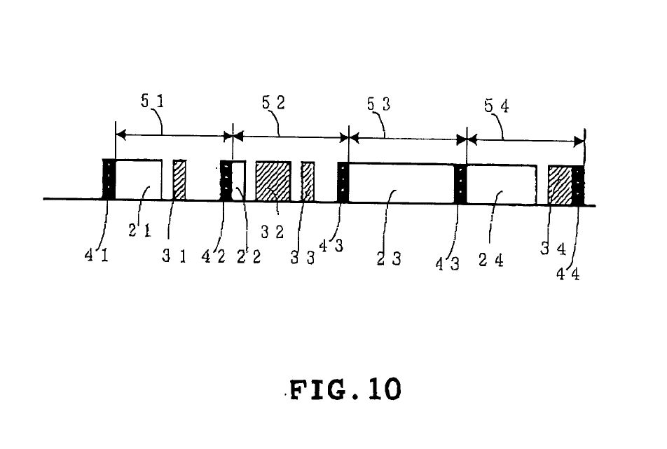

FIG. 10 is a timing chart showing the flow of packets on the main transmission channel 11. Clear-to-send packets from the time-division multiplexing controller 10 are forcefully transmitted even when another terminal is using the channel. Hence, if a terminal is using the main transmission channel 11 when a clear-to-send packet is transmitted, a conflict is generated. This method or forcefully generating collisions is called the “back pressure” method. The header portion of a clear-to-send packet is long enough that the transmission will continue, even when there is a collision, until the conflicting terminal stops transmitting. In other words, the body portion of the clear-to-send packet (the portion describing the terminal address authorized to use the timeslot) will begin transmitting after a collision has ended and the conflicting terminal has released the channel. At this time, the terminal authorized to use the timeslot according to the clear-to-send packet begins transmitting at once.

In the example shown in FIG. 10, the terminal 1 transmits the packet 21 immediately after the clear-to-send packet 41. The terminal 2 transmits the packet 22 immediately after the clear-to-send packet 42. Further transmissions continue in the same manner. In unused portions of each timeslot, packets 31, 32, 33, and 34 are sent according to the random access method.

Since collisions are forcefully brought about in the above configuration using the back pressure method, efficiency of using the transmission channel drops slightly. However, this configuration is advantageous in that it requires only one transmission channel, facilitating construction of the hardware and lowering production costs.

### INDUSTRIAL APPLICABILITY OF THE INVENTION

The communications network of the present invention mutually accommodates packets that require real-time transmission and those that do not with sufficient transmitting capacity, thereby achieving a high efficiency in line use.

1. A communications network comprising a main transmission channel having a broad band; a sub transmission channel having a narrow band; a plurality of terminals; a time-division controller for performing time-division control for the main transmission channel,
the communication network further comprising optical transmitter/receivers for inserting the sub transmission channel into a blank region in a frequency spectrum or the main transmission channel.

2. A communications method suitable for a communications network comprising a main transmission channel having a broad band; a sub transmission channel having a narrow band; a plurality of terminals; and a time-division controller for time-division control for the main transmission channel;
wherein control signals are transmitted through the sub transmission channel from the time-division controller to each of the terminals in order to perform the time-division control.

3. A communications method as recited in claim 2, wherein, after using only a needed time of an allocated timeslot, the terminal to which the timeslot was allocated releases the remaining time in the timeslot to other terminals as a remainder timeslot.

4. A communications method as recited in claim 2, wherein the terminals transmit requests for timeslot allocations to the time-division controller via the remainder timeslot using a contention protocol.

5. A communications method as recited in claim 2, wherein the terminals use a plurality of buffers classified according to the priority level of the packet, and packets from each terminal are transmitted in order of priority during the timeslots allocated to the terminal.

6. A communications method suitable for a communications network comprising a single main transmission channel; a plurality of terminals; and a time-division controller for performing time-division control for the single main transmission channel;
wherein the time-division controller allocates timeslots that forcefully generate collisions on the transmission channel according to the back pressure method; and
after using only a needed time of an allocated timeslot, the terminal to which the timeslot was allocated opens the remaining time in the timeslot to other terminals as a remainder timeslot.
